(19) United States
(12) Patent Application Publication
(10) Pub. No.: US 2018/0283283 A1
(43) Pub. Date: Oct. 4, 2018

(54) AIRCRAFT FIRE SAFETY WITH OIL PUMP DEPRIME VALVE

(71) Applicant: PRATT & WHITNEY CANADA CORP., Longueuil (CA)

(72) Inventors: Patrick MANOUKIAN, Saint-Laurent (CA); Patrice REMY, St-Hubert (CA); Sarah THERIAULT, Montreal (CA)

(21) Appl. No.: 15/471,540

(22) Filed: Mar. 28, 2017

(51) Int. Cl. F02C 9/00

(52) U.S. Cl. CPC F02C 9/00; F05D 2260/98

(57) ABSTRACT

Herein provided are methods and systems for controlling operation of a deprime valve of an engine of an aircraft. A windmilling condition for an engine, indicative of at least one rotatable component of the engine being driven while the engine is inoperative, is detected. A fire event condition, indicative of a fire in proximity to the engine, is detected. When the windmilling and fire event conditions are detected concurrently, a command is sent to the deprime valve to cause the deprime valve to be open for a predetermined period of time.

### TECHNICAL FIELD

The present disclosure relates generally to aircraft safety, and, more particularly, to fire safety systems on aircraft.

### BACKGROUND OF THE ART

Many aircraft have auxiliary power units (APU), typically mounted in a tailcone of an aircraft separate from other aircraft engines, which serve to supply electricity to various aircraft systems and to provide compressed air for the aircraft. The APU has a lubricating system which circulates a lubricating fluid, for example oil, between components of the APU.

In certain stages of operation of the aircraft where the APU is non-operational, air circulation in the vicinity of the APU can cause rotatable components of the APU to windmill. This, in turn, can cause lubricating fluid to circulate through the APU. In the event of a fire occurring in or around the APU, circulation of a lubricating fluid poses an additional fire risk.

As such, there is room for improvement.

### SUMMARY

In one aspect, there is provided a method for controlling operation of a deprime valve of an engine of an aircraft. The method comprises detecting a windmilling condition for the engine indicative of at least one rotatable component of the engine being driven while the engine is inoperative, detecting a fire event condition indicative of a fire in proximity to the engine, and upon detecting the windmilling condition and the fire event condition concurrently, sending a command to the deprime valve to cause the deprime valve to be open for a predetermined period of time.

In another aspect, there is provided a system for controlling operation of an engine of an aircraft. The system comprises a processing unit and a non-transitory computer-readable memory having stored thereon program instructions. The program instructions are executable by the processing unit for detecting a windmilling condition for the engine indicative of at least one rotatable component of the engine being driven while the engine is inoperative, detecting a fire event condition indicative of a fire in proximity to the engine, and upon detecting the windmilling condition and the fire event condition concurrently, sending a command to the deprime valve to cause the deprime valve to be open for a predetermined period of time.

### DESCRIPTION OF THE DRAWINGS

Reference is now made to the accompanying figures in which:

FIG. 1 is a schematic of an example aircraft;

FIG. 2 is a block diagram of an example auxiliary power unit (APU) having a deprime valve;

FIG. 3 is a schematic diagram of an example computing system for implementing the valve controller of FIG. 2 in accordance with an embodiment; and

FIG. 4 is a flowchart illustrating an example method for controlling operation of the deprime valve of FIG. 2, in accordance with an embodiment.

It will be noted that throughout the appended drawings, like features are identified by like reference numerals.

### DETAILED DESCRIPTION

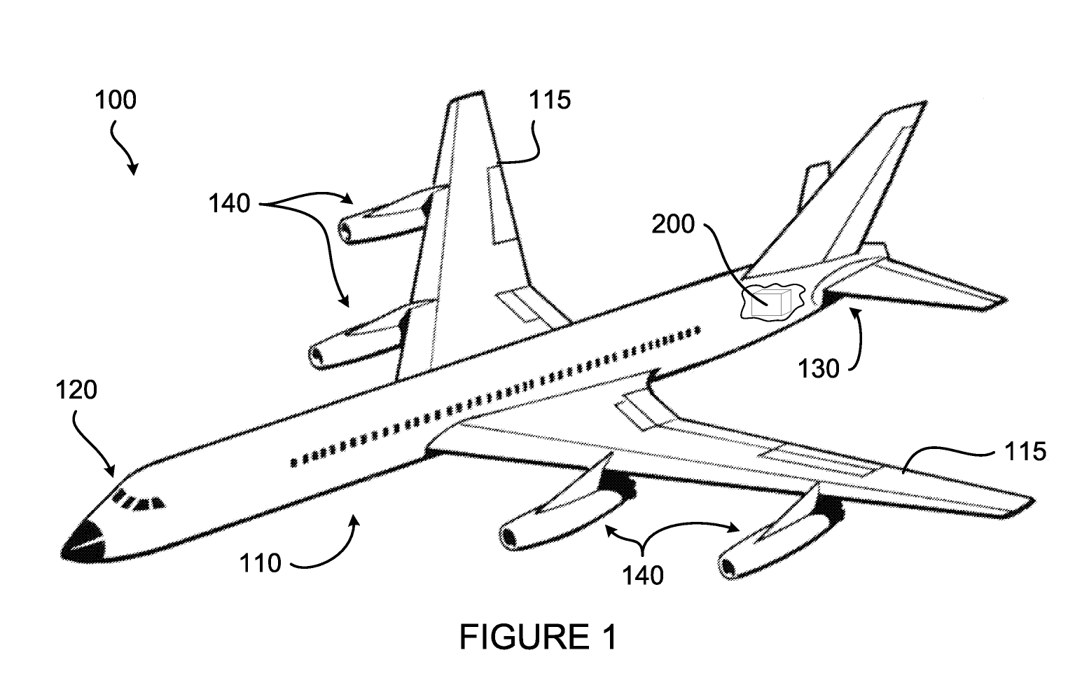

With reference to FIG. 1, there is illustrated an example aircraft 100 having a fuselage 110 and wings 115. The fuselage 110 includes a cockpit 120 and a tailcone 130, which can be substantially integral to the fuselage 110. The aircraft 100 also includes primary engines 140 which can be affixed to the wings 115 and/or to the fuselage 110. Although shown in FIG. 1 generally as a turbojet aircraft, it should be noted that the aircraft 100 can be any suitable type of aircraft.

In addition, the aircraft 100 can have an auxiliary power unit (APU) 200, a separate engine which provides power to various system components of the aircraft 100 under certain conditions. In some embodiments, the APU 200 is in an APU compartment, which can be located in the tailcone 130 of the fuselage 110; in other embodiments the APU compartment can be located elsewhere in the aircraft 100. The APU 200 serves as a source of power for the aircraft which supplies electricity for various aircraft systems, and in some embodiments also provides compressed air for the aircraft 100. The APU 200 may be started when the aircraft 100 is on the ground, or when the aircraft 100 is in flight. Additionally, depending on various operating conditions for the aircraft 100 and a flight stage in which the aircraft 100 is operating, the APU 200 can be in an operational state or a non-operational state, and can be switched between operational and non-operational states as is suitable, for example in response to any suitable triggers or commands.

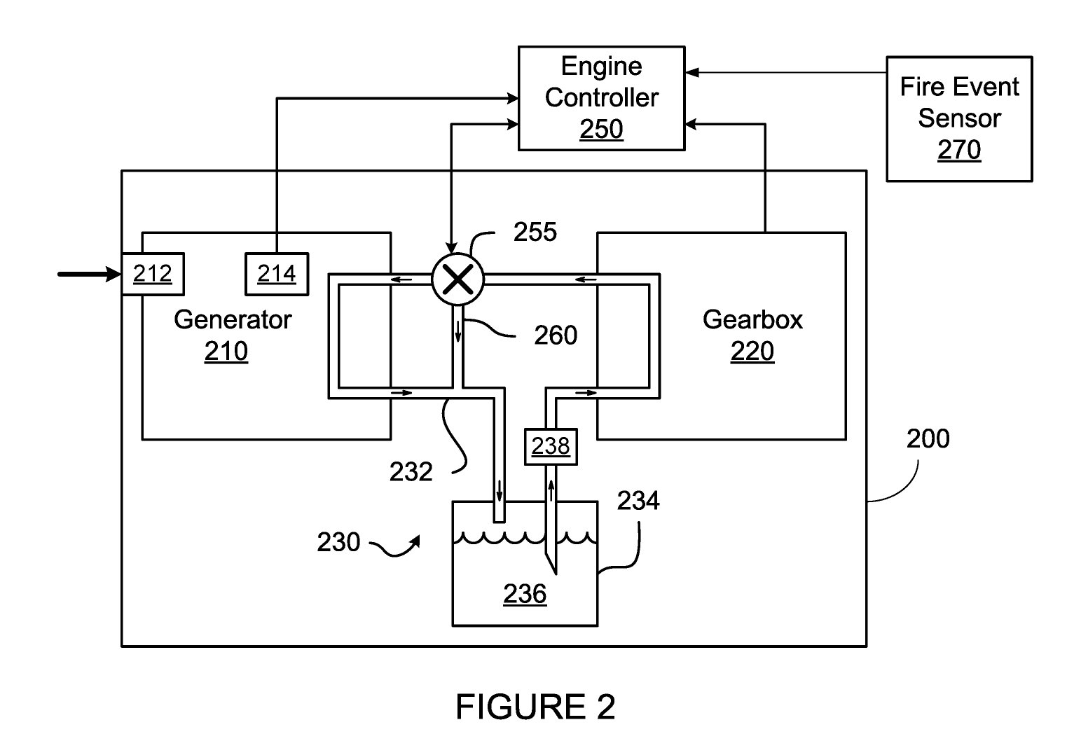

With reference to FIG. 2, an example embodiment of the APU 200 is shown. The APU 200 is composed of a generator 210, a gearbox 220, and a lubricating system 230 which is configured to circulate a lubricating fluid 236 through the APU 200. The engine inlet 212 can include a door, a scoop, or any other suitable closing mechanism. In addition, the APU 200 can have sensors 214 which are configured for obtaining information about the operation of the generator 210. The gearbox 220 can be any suitable gearbox for use with the generator 210. The lubricating fluid 236 can be any suitable type of lubricating fluid, including, for example, oil, synthetic oil, and the like.

The lubricating system 230 includes a circulatory structure 232 which feeds the lubricating fluid 236 from a reservoir 234 through the gearbox 220, generator 210, and other suitable components like heat exchangers of the APU 200. The circulatory structure 232 can include any suitable number of pipes, valves, joints, and the like. The lubricating system 230 also includes a pump 238 which is used to extract the lubricating fluid 236 from the reservoir 234 and can be used to force circulation of the lubricating fluid 236 through the circulatory structure 232. In addition, the lubricating system 230 can include any suitable number of heat exchangers (not illustrated), such as heat sinks, radiator coils, and the like, which can be standalone or integrated as part of the circulatory structure 232, the reservoir 234, the pump 238, or any suitable combination thereof.

The lubricating system further includes a deprime valve 255 controlled by an engine controller 250. The engine controller 250 is configured for causing the deprime valve 255 to operate in one of two modes of operation: when deactivated, or closed, the deprime valve 255 permits the flow of lubricating fluid 236 to the lubricating system components; when activated, or open, the deprime valve 255 stops the flow of the lubricating fluid 236 to the lubricating system components.

In order to control the operation of the deprime valve 255, the engine controller 250 is configured to receive input from various sensors and/or controls. In some embodiments, the engine controller 250 can receive inputs from a fire event sensor 270 which is configured to detect the occurrence of a fire event in the vicinity of the APU 200, for example in the APU compartment, and/or within the APU 200 itself. Although illustrated in FIG. 2 as being external to the APU 200, in some embodiments the fire event sensor 270 is part of the APU 200.

Additionally, the engine controller 250 can also receive inputs from one or more of the sensors 214 located in the generator 210 and/or from the gearbox 220. For example, the engine controller 250 can receive an input indicative of a rotational speed of one or more rotatable components of the APU 200, for example of the generator 210 and/or of the gearbox 220. In another example, the engine controller 250 can receive an input indicative of a position of a door of the engine inlet 212, for example indicating how open the door of the engine inlet 212 is, or of a size of an aperture of the door of the engine inlet 212. The engine controller 250 may also be configured to calculate how much air flows through the engine inlet 212 as a function of aircraft speed, altitude, temperature, and/or pressure. In some embodiments, the engine controller 250 also receives an input indicative of an operational status of the APU 200, 210. The operational status can be an indication of whether the APU 210 is running or not.

The engine controller 250 is configured to control the operation of the deprime valve 255 based on at least some of the various inputs described hereinabove. In some embodiments, the engine controller 250 is configured to activate the deprime valve 255 in response to the input received from the fire event sensor 270 and at least some of the sensors 214 and/or the gearbox 220. For example, when the engine controller 250 receives, from the fire event sensor 270, an indication of a fire event in a fire zone of the APU 200, and receives, from the sensors 214, an indication that rotatable components in the APU 200 are windmilling, the engine controller 250 can send a command to the deprime valve 255 to activate the deprime valve 255 for a predetermined period of time, thereby stopping flow of the lubricating fluid 236. Put differently, if the engine controller 250 detects a fire event condition indicative of the presence of a fire event in the vicinity of the APU and a windmilling condition indicative of the components of the generator 210 windmilling, the engine controller 250 causes the deprime valve 255 to open in order to prevent the flow of lubricating fluid into the system 230 for a certain amount of time, which can be based on existing regulatory safety requirements, or any other suitable metric.

In this fashion, the engine controller 250 can prevent circulation of the lubricating fluid 236, which may be flammable, through the system and/or to other components of the APU 200 for a period of time when components of the APU 200 are windmilling and a fire event is detected.

In some embodiments, the windmilling condition is detected by measuring a speed or rate of rotation of rotatable components of the APU 200, for example one or more elements of the gearbox 220 and/or the generator 210. For example, the sensors 214 can provide the engine controller 250 with an indication of the operational status of the engine and the speed of rotation of one or more components of the engine. In other embodiments, the windmilling condition can be detected based on one or more parameters for the engine inlet 212, for example a degree to which the engine inlet door is open, the size of the opening of the engine inlet door, the rate of flow of air through the engine inlet 212, a locking position for the engine inlet door, and the like. In still other embodiments, the speed or rate of rotation of rotatable components of the APU 200 and/or any of the parameters for the engine inlet door can be used as a confirmation of the windmilling condition. In some embodiments, the engine controller 250 verifies an operational status of the APU 200 or of the generator 210 generally prior to detecting the windmilling and fire event conditions.

It should be noted that the engine controller 250 can also send commands to activate or deactivate the deprime valve 255 in response to other input. For example, the engine controller 250 can send commands to activate and/or deactivate the deprime valve 255 at different points during the flight path of the aircraft 100, or based on other external conditions. At any point during flight, when the APU 200 is inoperative, if the engine controller 250 detects windmilling in the generator 210 and a fire event, the engine controller 250 is configured to send a command to activate the deprime valve 255 to stop the flow of the lubricating fluid 236.

In some embodiments, the engine controller 250 is further configured for receiving a confirmation from the deprime valve 255 indicating that the deprime valve has correctly been activated or deactivated. For example, following the sending of the command to activate the deprime valve 255, the engine controller 250 can receive a confirmation message from the deprime valve 255 which indicates whether the valve was successfully activated. In some embodiments, an additional sensor is placed near or at the deprime valve 255, or in the return line 260, and the additional sensor provides the confirmation message. In some embodiments, if the confirmation message indicates that the deprime valve 255 was not successfully activated, for example due to a mechanical failure or other issue, the engine controller 250 is configured to send a backup command to a backup control mechanism (not illustrated). The backup control mechanism can be used to stop the flow of the lubricating fluid. Alternatively, the engine controller 250 can send a backup command to the engine controller 280, which in turn activates the backup control mechanism.

In some embodiments, the engine controller 250 is also configured to monitor a health status for the deprime valve 255, which can be based on the information received from the deprime valve 255. For example, the engine controller 250 can measure an oil pressure signal rate or oil pressure threshold during a startup of the APU 200, which can be used to determine the health status of the deprime valve 255. In some embodiments, the engine controller 250 is configured to provide an indication, for example to a diagnostics system (not illustrated) when the health condition for the deprime valve 255 no longer meets a performance standard.

In some embodiments, the engine controller 250 can be implemented as a full-authority digital engine controls (FADEC) or other similar devices, including electronic engine controls (EEC), engine control units (EUC), and the like.

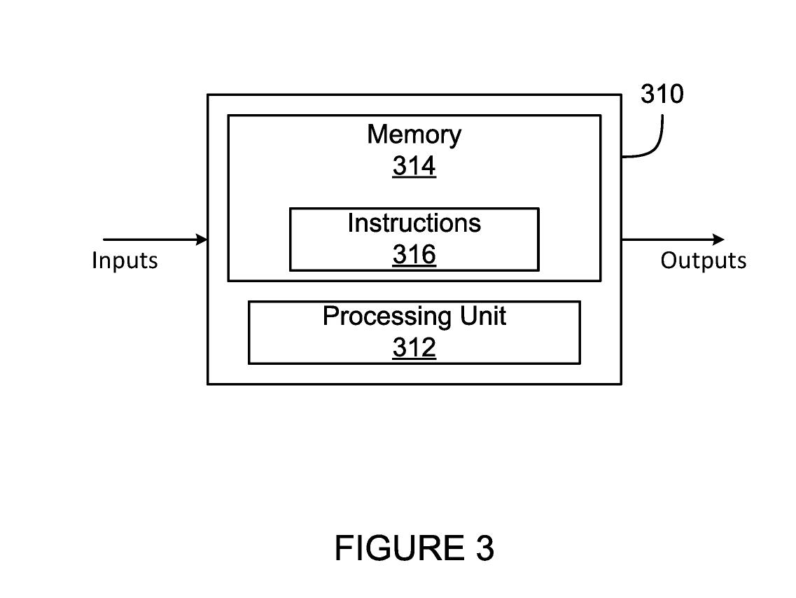

With reference to FIG. 3, the engine controller 250 may be implemented by a computing device 310, comprising a processing unit 312 and a memory 314 which has stored therein computer-executable instructions 316. The processing unit 312 may comprise any suitable devices configured to implement the engine controller 250 such that instructions 316, when executed by the computing device 310 or other programmable apparatus, may cause the functions/acts/steps attributed to the engine controller 250 as described herein to be executed. The processing unit 312 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 314 may comprise any suitable known or other machine-readable storage medium. The memory 314 may comprise non-transitory computer readable storage medium, for example, but not limited to, an electronic, magnetic, optical, electromagnetic, infrared, or semiconductor system, apparatus, or device, or any suitable combination of the foregoing. The memory 314 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 314 may comprise any storage means (e.g., devices) suitable for retrievably storing machine-readable instructions 316 executable by processing unit 312.

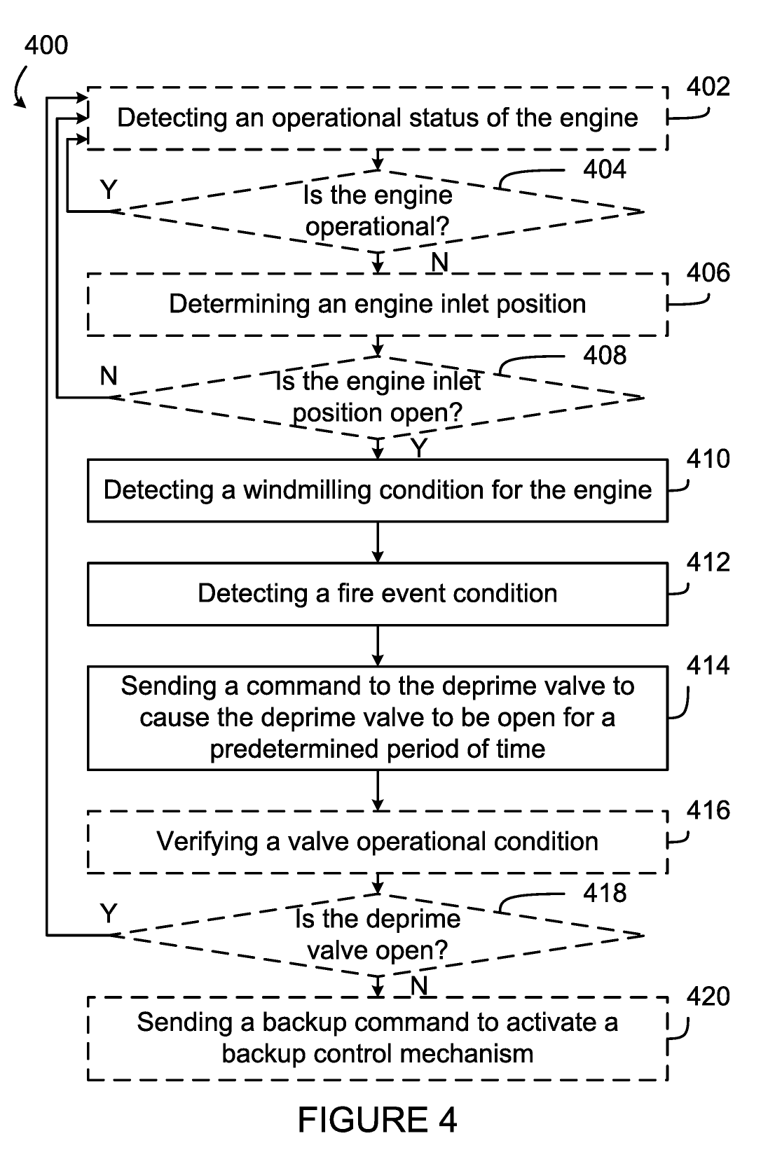

With reference to FIG. 4, there is shown a flowchart illustrating an example method 400 for controlling operation of a deprime valve of an engine of an aircraft, for example the deprime valve 255 of the APU 200 of the aircraft 100. The method 400 can be executed by the engine controller 250, which can be implemented as the computing device 310. Optionally, at step 402, the engine controller 250 detects an operational status of the APU 200. The operational status of the APU 200 can be detected via one or more sensors, for example the sensors 214 of the generator 210, or by any other suitable means. Optionally, at decision step 404, if the APU 200 is found to be operational, the method 400 returns to step 402. If the APU 200 is not operational, the method 400 continues, for example with step 406, or with step 410.

Optionally, at step 406, the engine controller 250 determines the position of an engine inlet door, for example the engine inlet 212 of the APU 210. The engine inlet door position can be indicative of whether the engine inlet 212 is open and/or of how open the engine inlet door 212 is. For example, the position of the engine inlet door can indicate a measure of how much air flows through the engine inlet 212, or any other suitable indication of whether the engine inlet door is open. Optionally, at decision step 408, if the engine inlet door position is determined not to be open, the method can return to a previous step of the method 400, for example step 402, or step 406. If the engine inlet door position is determined to be open, the method 400 continues with step 410.

At step 410, the engine controller 250 detects a windmilling condition for the APU 200. The windmilling condition can be detected based on inputs from sensors, for example the sensors 214 of the generator 210, from other components of the APU 200, for example the gearbox 220, or using any other suitable means. For example, the windmilling condition can be detected when rotatable components of the APU 200, for example in the generator 210, are rotating while the APU 200 is inoperative. In another example, the windmilling condition can be detected when the engine inlet 212 is in an open position while the APU 200 is inoperative. The windmilling condition can also be detected in other ways, for example based on default settings for the aircraft which, for example, require the engine inlet 212 to be locked open during certain stages of flight for the aircraft 100.

At step 412, the engine controller 250 detects a fire event condition for the APU 200. The fire event condition can be detected based on, for example, input from the aircraft fire sensor 270, which is located externally to the APU 200. The fire event condition can be indicative of a fire event in the APU 200, in the APU compartment where the APU 200 is located, in the vicinity of the APU 200, or in any other location which may pose a fire event risk for the APU 200.

At step 414, when both the windmilling condition and the fire event condition are detected, the engine controller 250 sends a command to the deprime valve 255 to cause the deprime valve 255 to activate, i.e. to be open, for a predetermined period of time. This stops a flow of lubricating fluid, for example lubricating fluid 236. The command can be sent using any suitable means and any suitable protocol. For example the command can be sent using fly-by-wire technology and/or fly-by-wireless technology. The predetermined period of time can be any suitable period of time, for example based on regulatory safety requirements or another suitable metric.

Optionally, at step 416, the engine controller 250 verifies a valve operational condition after the command has been sent at step 414. The valve operational condition can confirm whether the deprime valve 255 was correctly activated to open by the command sent at step 414. For example, the valve operational condition can be provided by a sensor of the deprime valve 255 or a sensor which is located in the return line 260. Optionally, at decision step 418, if the valve operational condition indicates that the deprime valve 255 did correctly open after being sent the command, the method 400 can return to some previous step, such as steps 402, 406, or 410. If the valve operational condition indicates that the deprime valve 255 was not properly activated to open, the method 400 continues to step 420.

Optionally, at step 420, a backup command can be sent to activate a backup control mechanism. The backup command can be sent by the engine controller 250 or another component of the APU 200, as appropriate. The backup command can indicate, for example, that the deprime valve 255 has failed to stop the flow of lubricating fluid 236, and that a backup mechanism should be activated. The backup mechanism can be any suitable system or mechanism for preventing the flow of lubricating fluid 236 from reaching the APU 200, and can involve alternate flow paths, alternate pumping arrangements, or any other suitable solution.

It should be noted that certain optional steps are linked, such that if one optional step is accomplished, another is to be accomplished with it. For example, steps 402 and 404 are linked, so if step 402 is performed, step 404 must also be performed. Similarly, steps 406 and 408 are linked, as are steps 416, 418, and 420. Although any combination of these linked steps can be performed, for example both sets of steps 402, 404 and 416, 418, 420, step 402 cannot be performed without step 404 also being performed, step 406 cannot be performed without step 408 also being performed, etc.

Although the preceding discussion has focused on the use of a deprime valve in an APU, such as the APU 200, similar techniques can be applied to other engines of the aircraft 100, including the engines 140, or any other suitable engine of the aircraft 100. In addition, while the deprime valve 255 was shown as being positioned between the generator 210 and the gearbox 220 in the circulatory structure 232, it should be noted that the deprime valve 255 can be located at any other suitable location along the circulatory structure 232, and can stop the flow of lubricating fluid 236 along other paths or using other techniques.

The methods and systems for controlling operation of a deprime valve of an engine of an aircraft described herein may be implemented in a high level procedural or object oriented programming or scripting language, or a combination thereof, to communicate with or assist in the operation of a computer system, for example the computing device 310. Alternatively, the methods and systems for controlling operation of the deprime valve may be implemented in assembly or machine language. The language may be a compiled or interpreted language. Program code for implementing the methods and systems for controlling operation of the deprime valve may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for controlling operation of the deprime valve may also be considered to be implemented by way of a non-transitory computer-readable storage medium having a computer program stored thereon. The computer program may comprise computer-readable instructions which cause a computer, or more specifically the processing unit 312 of the computing device 310, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for controlling operation of a deprime valve of an engine of an aircraft may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for controlling operation of a deprime valve of an engine of an aircraft, comprising:
detecting a windmilling condition for the engine indicative of at least one rotatable component of the engine being driven while the engine is inoperative;
detecting a fire event condition indicative of a fire in proximity to the engine; and
upon detecting the windmilling condition and the fire event condition concurrently, sending a command to the deprime valve to cause the deprime valve to be open for a predetermined period of time.

2. The method of claim 1, wherein detecting the windmilling condition for the engine comprises:
measuring a rotational speed of the at least one rotatable component of the engine; and
confirming the windmilling condition when the rotational speed of the at least one rotatable component is above a predetermined rotation threshold.

3. The method of claim 2, further comprising:
detecting an operational status of the engine; and
confirming the windmilling condition when the engine is inoperative.

4. The method of claim 1, further comprising determining an engine inlet door position, wherein detecting the windmilling and fire event conditions are performed when the engine inlet door position corresponds to an open position.

5. The method of claim 4, wherein the open position is confirmed when the engine inlet door is open beyond a predetermined threshold.

6. The method of claim 1, further comprising:
after sending the command, verifying a valve operational condition indicative of whether the deprime valve was successfully opened; and
when the valve operational condition is indicative of the deprime valve not being open, sending a backup command to activate a backup control mechanism.

7. The method of claim 1, wherein the engine is an auxiliary power unit.

8. The method of claim 1, wherein the engine is an auxiliary power unit (APU) located in an APU compartment of the aircraft, and wherein the fire event condition is indicative of a fire in the APU compartment.

9. The method of claim 1, wherein sending a command comprises sending a command to the deprime valve from an engine controller.

10. A system for controlling operation of an engine of an aircraft, comprising:
a processing unit; and
a non-transitory computer-readable memory having stored thereon program instructions executable by the processing unit for:
detecting a windmilling condition for the engine indicative of at least one rotatable component of the engine being driven while the engine is inoperative;
detecting a fire event condition indicative of a fire in proximity to the engine; and
upon detecting the windmilling condition and the fire event condition concurrently, sending a command to the deprime valve to cause the deprime valve to be open for a predetermined period of time.

11. The system of claim 10, wherein determining the windmilling condition for the engine comprises:
measuring a rotational speed of the at least one rotatable component of the engine; and
confirming the windmilling condition when the rotational speed of the at least one rotatable component is above a predetermined rotation threshold.

12. The system of claim 10, further comprising:
detecting an operational status of the engine; and
confirming the windmilling condition when the engine is inoperative.

13. The system of claim 10, the program instructions being further executable for determining an engine inlet door position, wherein detecting the windmilling and fire event conditions are performed when the engine inlet door position corresponds to an open position.

14. The system of claim 13, wherein the open position is confirmed when the engine inlet door is open beyond a predetermined threshold.

15. The system of claim 10, wherein the program instructions are further executable for:
after sending the command, verifying a valve operational condition indicative of whether the deprime valve was successfully open; and
when the valve operational condition is indicative of the deprime valve not being open, sending a backup command to activate a backup control system.

16. The system of claim 10, wherein the engine is an auxiliary power unit.

17. The system of claim 10, wherein the engine is an auxiliary power unit (APU) located in an APU compartment of the aircraft, and wherein the fire event condition is indicative of a fire in the APU compartment.

18. The system of claim 10, wherein sending a command comprises sending a command to the deprime valve from an engine controller.
